(19) United States
(12) Patent Application Publication
(10) Pub. No.: US 2026/0121485 A1
(43) Pub. Date: Apr. 30, 2026

(54) PENDULUM GENERATOR

(71) Applicant: Ho Yan SUN, Kowloon (HK)

(72) Inventors: Siu Hong SUN, Kwai Chung (HK); Ho Yan SUN, Kowloon (HK)

(21) Appl. No.: 18/932,873

(22) Filed: Oct. 31, 2024

(51) Int. Cl. H02K 7/18; F03G 3/06; F03G 3/08; H02K 7/02

(52) U.S. Cl. CPC H02K 7/1853; F03G 3/06; F03G 3/08; H02K 7/02

(57) ABSTRACT

The present application relates to a pendulum generator. The pendulum generator comprises a swinging frame, a pusher, a crossbar, a pendulum, a one-way bearing, a power generation device and a chain. The pusher is configured to drive the swinging frame to oscillate. When the swinging frame oscillates, the pendulum is driven to oscillate by the crossbar. The pendulum can continue oscillating due to inertia, and drives the crossbar to rotate and the swinging frame to oscillate. The one-way bearing is mounted on the crossbar, wherein the one-way bearing rotates in a single direction when the pendulum drives the crossbar to rotate. The one-way bearing comprises a bearing body and a gear positioned on an exterior of the bearing body. The power generation device comprises a main body and a flywheel. The chain connects the gear and the flywheel to transmit rotational motion from the one-way bearing to the flywheel.

### TECHNICAL FIELD

The present disclosure relates to a field of power generation equipment, and in particular to a pendulum generator.

### BACKGROUND

In conventional power generation, fossil fuel combustion or natural energy sources such as wind and hydropower are commonly used. However, these methods either contribute to environmental pollution or are constrained by natural conditions, making it difficult to provide a continuous and stable power supply. Moreover, in remote areas, challenges such as high construction costs for power generation facilities, limited grid coverage, and unstable power transmission often arise, significantly impacting the reliability of electricity supply and hindering local economic activities and daily life. Therefore, what is needed is a low-cost clean energy generator that overcome the above-mentioned disadvantages.

### SUMMARY

According to various embodiments of the present disclosure, a pendulum generator is provided.

A pendulum generator comprising:

a swinging frame;

a pusher configured to drive the swinging frame to oscillate;

a crossbar mounted on the swinging frame, the crossbar oscillating with the swinging frame and being rotatable relative to the swinging frame around a central axis of the crossbar;

a pendulum fixedly connected to the crossbar, wherein when the swinging frame oscillates, the pendulum is driven to oscillate by the crossbar; the pendulum is able to continue oscillating under an action of inertia, and drives the crossbar to rotate and the swinging frame to oscillate;

a one-way bearing mounted on the crossbar, wherein the one-way bearing rotates in a single direction when the pendulum drives the crossbar to rotate; the one-way bearing comprises a bearing body and a gear positioned on an exterior of the bearing body;

a power generation device comprising a main body and a flywheel, the flywheel being connected to the main body, and wherein a rotation of the flywheel drives the main body to generate electricity; and

a chain connecting the gear and the flywheel to transmit rotational motion from the one-way bearing to the flywheel.

In an embodiment, the pendulum comprises an arm connected to the crossbar and a bob connected to the arm; the pendulum generator further comprises a roller bracket; the roller bracket is located at a bottom of the bob to support the bob, and the roller bracket is in sliding contact with the bob.

In an embodiment, the roller bracket comprises a plurality of rollers arranged in parallel and in an arc shape; a bottom surface of the bob that makes contact with the rollers has the same arc shape.

In an embodiment, further comprising a base; the base comprises a base body, a rod and a connecting bearing; the roller bracket is mounted on the base body; the swinging frame is mounted on the rod; the rod is rotatably connected to the base body via the connecting bearing.

In an embodiment, the pusher is designed to be powered electrically.

In an embodiment, the pusher is designed to be powered manually.

In an embodiment, the number of the one-way bearing is two, both of the one-way bearings are mounted on the crossbar; rotating directions of the one-way bearings are reverse;

a number of the power generation devices is two, each corresponding to one of the one-way bearings.

In an embodiment, the power generation device further comprises an accumulator; the accumulator is connected with the main body to store electricity.

Details of one or more embodiments of the present disclosure will be given in the following description and attached drawings. Other features, objects and advantages of the present disclosure will become apparent from the description, drawings, and claims.

### BRIEF DESCRIPTION OF THE DRAWINGS

In order to better describe and illustrate the embodiments and/or examples of the contents disclosed herein, reference may be made to one or more drawings. Additional details or examples used to describe the drawings should not be considered as limiting the scope of any of the disclosed contents, the currently described embodiments and/or examples, and the best mode of these contents currently understood.

FIG. 1 illustrates a perspective view of a pendulum generator according to an embodiment of the present disclosure.

### DETAILED DESCRIPTION OF THE EMBODIMENTS

In order to facilitate the understanding of the present disclosure, the present disclosure will be described more fully below with reference to the relevant drawings. Preferred embodiments of the present disclosure are shown in the drawings. However, the present disclosure can be implemented in many different forms and is not limited to the embodiments described herein. On the contrary, the purpose of providing these embodiments is to make the disclosure of the present disclosure more thorough and comprehensive.

Unless otherwise defined, all technical and scientific terms used herein have the same meaning as commonly understood by one of ordinary skill in the art to which this invention belongs. The definitions are provided to aid in describing particular embodiments, and are not intended to limit the claimed invention. The term “and/or” used herein includes any and all combinations of one or more related listed items.

In order to understand this application thoroughly, detailed steps and structures will be provided in the description below to explain the technical solution proposed by this application. Preferred embodiments of this application are described in detail below. However, in addition to these details, there may be other embodiments of this application.

It should be noted that when an element is referred to as being “fixed to” another element, it can be directly on another element or an intervening element may also be present there between. When an element is considered to be “connected to” another element, it can be directly connected to another element or an intervening element may be present at the same time. Terms “inner”, “outer”, “upper”, “lower”, “left”, “right” and similar expressions used herein are for illustrative purposes only, and do not mean that they are the only embodiments.

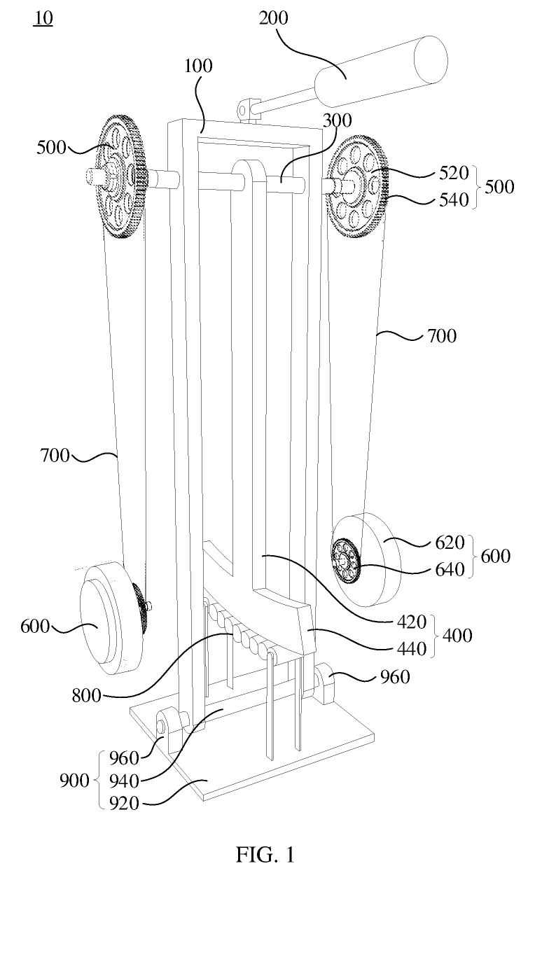

Referring to FIG. 1, a pendulum generator 10 comprises a swinging frame 100, a pusher 200, a crossbar 300, a pendulum 400, a one-way bearing 500, a power generation device 600, and a chain 700. The pusher 200 is configured to drive the swinging frame 100 to oscillate. The pusher 200 can continuously extend and retract to drive the swinging frame 100 back and forth. The crossbar 300 is mounted on the swinging frame 100. The crossbar 300 oscillates with the swinging frame 100 and is rotatable relative to the swinging frame 100 around a central axis of the crossbar 300. In one embodiment, the swinging frame 100 can be provided with a hole for mounting the crossbar 300. The crossbar 300 can be connected to the swinging frame 100 through a bearing to reduce friction. The pendulum 400 is fixedly connected to the crossbar 300. In one embodiment, the pendulum 400 and the crossbar 300 can be connected through welding.

When the swinging frame 100 oscillates, the pendulum 400 is driven to oscillate by the crossbar 300. The pendulum 400 is able to continue oscillating under an action of inertia, and drives the crossbar 300 to rotate and the swinging frame 100 to oscillate. The pendulum 400 will swing under the influence of inertia, achieving continuous power generation. In an embodiment, the pusher 200 can continuously drive the swinging frame 100. The force required to continuously drive the swinging frame 100 is smaller due to the pendulum’s 400 inertia. In one embodiment, the pendulum 400 can oscillate 60 to 70 times per minute. In an embodiment, the pusher 200 usually can’t stop working. If the pusher 200 stops, the power generation process will cease.

The one-way bearing 500 is mounted on the crossbar 300, wherein the one-way bearing 500 rotates in a single direction when the pendulum 400 drives the crossbar 300 to rotate. The one-way bearing 500 comprises a bearing body 520 and a gear 540 positioned on an exterior of the bearing body 520.

The power generation device 600 comprises a main body 620 and a flywheel 640. The flywheel 640 is connected to the main body 620, and wherein the rotation of the flywheel 640 drives the main body 620 to generate electricity. The chain 700 connects the gear 540 and the flywheel 640 to transmit rotational motion from the one-way bearing 500 to the flywheel 640.

In an embodiment, the number of the one-way bearings 500 is two. Both of the one-way bearings 500 are mounted on the crossbar 300. Rotating directions of the one-way bearings 500 are reverse. the number of power generation devices 600 is two, each corresponding to one of the one-way bearings 500. As the pendulum 400 swings, it alternately drives the two one-way bearings 500, thereby utilizing the force from both directions during full oscillation.

After the pusher 200 is activated, the pusher 200 can continuously extend and retract to drive the swinging frame 100 and pendulum 400 back and forth. In an embodiment, the push 200 needs to synchronize with the swinging speed of the pendulum 400. The movement speed of the push 200 must match the swinging speed of the pendulum 400 for the pendulum generator 10 to generate electricity. In one embodiment, the power generated by the leftward swing causes one one-way bearing 500 to rotate 45 degrees to the left, while the rightward swing causes the other one-way bearing 500 to rotate 45 degrees to the right. Each one-way bearing 500 rotates in a single direction. As the pendulum 400 swings back and forth, the pendulum 400 alternately drives both one-way bearings 500, which in turn drive two flywheels 640 to rotate to generate electricity.

In an embodiment, the pendulum 400 comprises an arm 420 connected to the crossbar 300 and a bob 440 connected to the arm 420. The pendulum generator 10 further comprises a roller bracket 800. The roller bracket 800 is located at the bottom of the bob 440 to support the bob 440, and the roller bracket 800 is in sliding contact with the bob 440.

Due to the weight of the pendulum 400 bob 440, the pendulum 400 creates great friction with the components connected to it during swinging, which results in deceleration. In this embodiment, the roller bracket 800 is installed beneath the bob 440, allowing most of the pendulum 400’s weight to rest on the roller bracket 800. This reduces the pressure on other components, thereby decreasing friction. As a result, the energy consumption during oscillation is reduced, allowing the pendulum 400 to swing more efficiently.

To be specific, in an embodiment, the roller bracket 800 comprises a plurality of rollers arranged in parallel and in an arc shape. The bottom surface of the bob 440 that makes contact with the rollers has the same arc shape. In this embodiment, the roller bracket 800 continuously supports the pendulum 400 throughout the swinging process.

In some embodiments, the pendulum generator 10 can further comprise a base 900. The base 900 comprises a base body 920, a rod 940 and a connecting bearing 960. The roller bracket 800 can be mounted on the base body 920, while the swinging frame 100 is mounted on the rod 940. The rod 940 is rotatably connected to the base body 920 via the connecting bearing 960 to reduce friction. In other embodiments, the base body 920 can be the grand or floor of a room.

In some embodiments, the pusher 200 can be designed to be powered electrically. In an embodiment, the pendulum generator 10 can further comprise a time switch to control the pusher 200. When electricity is available, it can be stored for use in areas with unstable power systems. In one embodiment, the voltage to start the pusher 200 can be 220V, with a current of 0.002A. In other embodiments, the pusher 200 can be designed to be powered manually.

In an embodiment, the power generation device 600 further comprises an accumulator. The accumulator is connected with the main body 620 to store electricity.

In one embodiment, the power generation device 600 can prod 940uce three-phase alternating current (AC). In this embodiment, the voltage generated by each one-way bearing 500 can be 36V. The three-phase AC is rectified to direct current (DC) and then stored in the accumulator. The generated electricity can be used to power the pusher 200 or connected to a power system for other electrical devices. In one embodiment, the output current after rectification can be 4A.

The size and weight of the pendulum generator 10 can be adjusted according to the power generation requirements. Different parts of the pendulum generator 10 are made from various metals, such as stainless steel and aluminum. In one embodiment, the material of the swinging frame 100 can be aluminum.

The pendulum generator 10 utilizes the reciprocating motion of the pendulum 400 to convert mechanical energy into electrical energy. It is a green energy generation technology that offers advantages such as no need for additional fuel, a simple structure, and low operating costs. Under the influence of inertia, the pendulum 400 continuously drives the power generation device 600 to prod 940uce electricity through the coordinated work of multiple components. Additionally, by incorporating an electrically or manually driven pusher 200, the system’s startup efficiency and energy conversion sustainability can be significantly enhanced.

This pendulum generator 10 is not limited by environmental or regional constraints and can be constructed as needed to provide power. The pendulum generator 10 can be used for electricity in urban or rural settings, as well as for charging independent buildings or electric vehicles, without causing environmental pollution. Furthermore, its low construction cost allows for the provision of clean and affordable energy to underdeveloped areas, improving the quality of life for local residents.

The technical features in the foregoing embodiments may be randomly combined. For a concise description, not all possible combinations of the technical features in the embodiment are described. However, provided that combinations of the technical features do not conflict with each other, the combinations of the technical features are considered as falling within the scope recorded in this specification.

The foregoing embodiments only describe several implementations of the disclosure, which are described specifically and in detail, and therefore cannot be construed as a limitation to the patent scope of the disclosure. It should be noted that, a person of ordinary skill in the art may further make variations and improvements without departing from the ideas of the disclosure, which all fall within the protection scope of the disclosure. Therefore, the protection scope of the disclosure is subject to the protection scope of the appended claims.

What is claimed is:

1. A pendulum generator comprising:
a swinging frame;
a pusher configured to drive the swinging frame to oscillate;
a crossbar mounted on the swinging frame, the crossbar oscillating with the swinging frame and being rotatable relative to the swinging frame around a central axis of the crossbar;
a pendulum fixedly connected to the crossbar, wherein when the swinging frame oscillates, the pendulum is driven to oscillate by the crossbar; the pendulum is able to continue oscillating under an action of inertia, and drives the crossbar to rotate and the swinging frame to oscillate;
a one-way bearing mounted on the crossbar, wherein the one-way bearing rotates in a single direction when the pendulum drives the crossbar to rotate; the one-way bearing comprises a bearing body and a gear positioned on an exterior of the bearing body;
a power generation device comprising a main body and a flywheel, the flywheel being connected to the main body, and wherein a rotation of the flywheel drives the main body to generate electricity; and
a chain connecting the gear and the flywheel to transmit rotational motion from the one-way bearing to the flywheel.

2. The pendulum generator of claim 1, wherein the pendulum comprises an arm connected to the crossbar and a bob connected to the arm; the pendulum generator further comprises a roller bracket; the roller bracket is located at a bottom of the bob to support the bob, and the roller bracket is in sliding contact with the bob.

3. The pendulum generator of claim 2, wherein the roller bracket comprises a plurality of rollers arranged in parallel and in an arc shape; a bottom surface of the bob that makes contact with the rollers has the same arc shape.

4. The pendulum generator of claim 2, further comprising a base; the base comprises a base body, a rod and a connecting bearing; the roller bracket is mounted on the base body; the swinging frame is mounted on the rod; the rod is rotatably connected to the base body via the connecting bearing.

5. The pendulum generator of claim 1, wherein the pusher is designed to be powered electrically.

6. The pendulum generator of claim 1, wherein the pusher is designed to be powered manually.

7. The pendulum generator of claim 1, wherein the number of the one-way bearing is two, both of the one-way bearings are mounted on the crossbar; rotating directions of the one-way bearings are reverse;
a number of the power generation devices is two, each corresponding to one of the one-way bearings.

8. The pendulum generator of claim 1, wherein the power generation device further comprises an accumulator; the accumulator is connected with the main body to store electricity.
